(19) United States
(12) Patent Application Publication
(10) Pub. No.: US 2014/0251558 A1
(43) Pub. Date: Sep. 11, 2014

(54) SUPPORT STRUCTURE FOR INCREASING FIXING FORCE OF A CURTAIN

(71) Applicant: Tser Wen CHOU, Taipei City (TW)

(72) Inventor: Tser Wen CHOU, Taipei City (TW)

(21) Appl. No.: 13/785,641

(22) Filed: Mar. 5, 2013

(51) Int. Cl. E06B 9/42

(52) U.S. Cl. CPC E06B 9/42
USPC 160/323.1

(57) ABSTRACT

A support structure for increasing fixing force of a curtain. The support structure includes an insert body including a main body with a central hollow structure and a metal pin body. The metal pin body can be plugged into the hollow structure of the main body. The metal pin body has a protruding cylindrical rod section. The insert body is received in a central socket of the curtain control seat. The curtain control seat has two protruding engagement bodies disposed on two sides of the central socket. The protruding cylindrical rod section of the metal pin body is inserted into the through hole of the fixing bracket and the engagement bodies are correspondingly fixedly engaged with rectangular perforations of the fixing bracket. Accordingly, the fixing force of the curtain is increased and the stability of the curtain sheet is enhanced.

### BACKGROUND OF THE INVENTION

1. Field of the Invention

The present invention relates generally to a curtain support structure, and more particularly to a support structure for enhancing fixing effect of a curtain.

2. Description of the Related Art

The conventional curtain support structure generally has two fixing brackets respectively disposed on two sides of the curtain control seat. The entire curtain assembly is located on the fixing brackets by means of screws or fixing plates protruding from the fixing brackets.

In the conventional curtain support structure, only the screws or the fixing plates provide support force for the curtain assembly so that the support force is quite weak. When a downward pulling force is applied to the curtain, the screws or the fixing plates tend to loosen or bend. In this case, the curtain assembly can be hardly securely fixed.

### SUMMARY OF THE INVENTION

It is therefore a primary object of the present invention to provide a curtain support structure capable of increasing the fixing effect of the curtain. The support structure includes an insert body having a protruding cylindrical pin body for connecting with the fixing bracket and the curtain assembly. By means of the support structure, the problem of the conventional curtain support structure that the screws or fixing plates tend to loosen or bend can be solved and the stability of move of the curtain sheet can be enhanced.

To achieve the above and other objects, the insert body of the support structure of the present invention includes an insert body for connecting with the curtain assembly. The curtain assembly includes a curtain rail, two fixing brackets and a curtain control assembly.

The curtain rail includes a rail main body and a reverse T-shaped structure extending from inner face of the rail main body.

The two fixing brackets are inserted into the inner face of the curtain rail from two sides of the rail. Each fixing bracket has a horizontal face and a vertical face. The horizontal face is formed with a split, whereby the horizontal face of the fixing bracket can be fixedly inserted in the inner face of the curtain rail with the reverse T-shaped structure of the curtain rail passing through the split. The vertical face is formed with rectangular perforations and a central through hole.

The curtain control assembly includes a curtain control seat, a curtain sheet reel and a curtain sheet lower weight. An outer end face of the curtain control seat is formed with a central socket the insert body to plug in. Two protruding engagement bodies are disposed on two sides of the central socket. The engagement bodies are correspondingly engaged with the rectangular perforations of the fixing bracket and hung on the fixing bracket.

The insert body includes a main body with a central hollow structure and a metal pin body, which can be plugged into the hollow structure of the main body. The metal pin body has an engagement notch for locating the metal pin body in the hollow structure. The metal pin body also has a protruding cylindrical rod section for connecting the fixing bracket and the curtain control seat.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective exploded view of the insert body of the present invention;

FIG. 3 is a perspective assembled view of the insert body of the present invention;

FIG. 4 is a perspective view showing that the insert body is to be plugged into the central socket of the control seat;

FIG. 5 is a perspective view showing that the insert body is to be connected with the fixing bracket;

FIG. 6 is a perspective view showing that the fixing bracket is to be connected with the rail;

FIG. 7 is a sectional view of the present invention, showing the installation thereof;

FIG. 8 is a perspective view showing that two sides of the rail are covered by the cover boards; and

FIG. 9 shows that the installation of the present invention is completed.

### DETAILED DESCRIPTION OF THE PREFERRED EMBODIMENTS

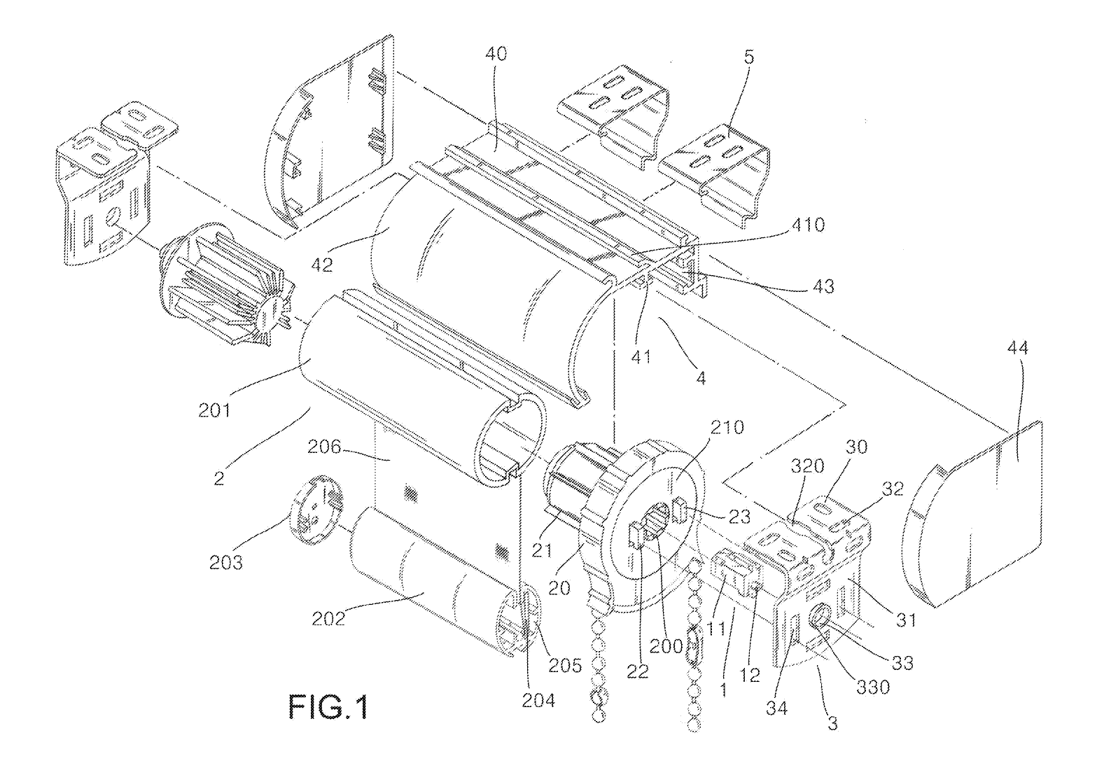

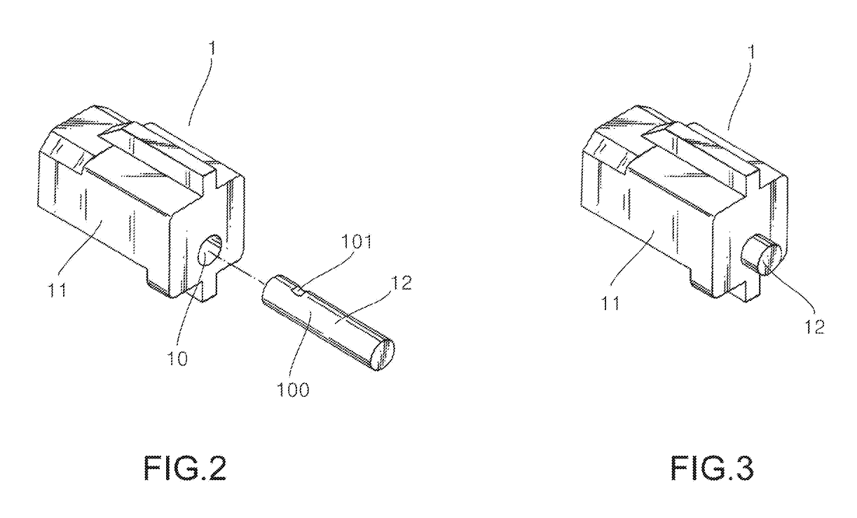

Please refer to FIG. 1, which is a perspective exploded view of the curtain support structure of the present invention. The curtain support structure includes an insert body 1 for connecting with a curtain assembly 2 and a fixing bracket so as to fix the entire curtain on a window wall face to provide sunshade effect. The insert body 1 (as shown in FIG. 2) includes a main body 11 with a hollow structure 10 and a metal pin body 100, which can be plugged into the hollow structure 10 of the main body 11. The metal pin body 100 has an engagement notch 101 for locating the metal pin body 100 in the hollow structure 10. A cylindrical rod section 12 of the metal pin body 100 protrudes from the hollow structure 10 (as shown in FIG. 3). The curtain assembly includes a curtain rail 4, two cover boards 44 disposed at two ends of the curtain rail 4, two fixing brackets 3 fixed on inner face of the curtain rail, a curtain control assembly 2 composed of a curtain control seat 20, a curtain sheet reel 201 and a curtain sheet lower weight 202, hanging brackets 5 for fixing the entire curtain assembly on the wall face, and the insert body 6 for connecting with the curtain control seat 40 and the fixing bracket 3.

The curtain control assembly 2 includes a control seat 20, a curtain sheet reel 201, a curtain sheet lower weight 202 and side cover 203. The control seat 20 has a rotary connection seat 21 on one side for rotatably fitting with the curtain sheet reel 201. The other side of the control seat 20 is a closed face 210. The closed face 210 is formed with a central socket 200 for the main body 11 of the insert body 1 to plug in. Two protruding engagement bodies 22, 23 are disposed on two sides of the central socket 200. The engagement bodies 22, 23 are correspondingly engaged with and hung on the fixing bracket 3. The curtain sheet lower weight 202 is a symmetrical structure. A locating plate 204 is fitted through the interior space of the curtain sheet lower weight 202. The curtain sheet 206 outward extends through an upper split 205 of the lower weight 202. Two ends of the lower weight 202 are sealed with the side covers 203.

The fixing bracket 3 is made of metal material, having a horizontal face 30 and a vertical face 31. The horizontal face 30 is formed with symmetrically arranged slots 32. In addition, a front edge of the horizontal face 30 is formed with an elongated split 320 lengthwise extending from the horizontal face 30 to an upper edge of the vertical face 31. The vertical face 31 is formed with a through hole 33 for receiving the rod section 12 of the main body 11 of the insert body 1. A hub section 330 is formed around the through hole 33. Four sides of the through hole 33 are respectively formed with rectangular perforations 34 for the engagement bodies 22, 23 of the closed face 210 of the control seat 20 to pass through and hang on.

The rail 4 includes a rail main body 40 and a reverse T-shaped structure 41 downward extending from inner face of the rail main body 40. A hook rail 410 is formed on outer face of the rail main body 40 opposite to the reverse T-shaped structure 41 for hooking the hanging brackets 5. A front end of the rail main body 40 has an arched decorative board 42. A rear end of the rail main body 40 is formed with a receiving space 43 for receiving a bottom end of the curtain sheet. Two sides of the rail are covered by the cover boards 44.

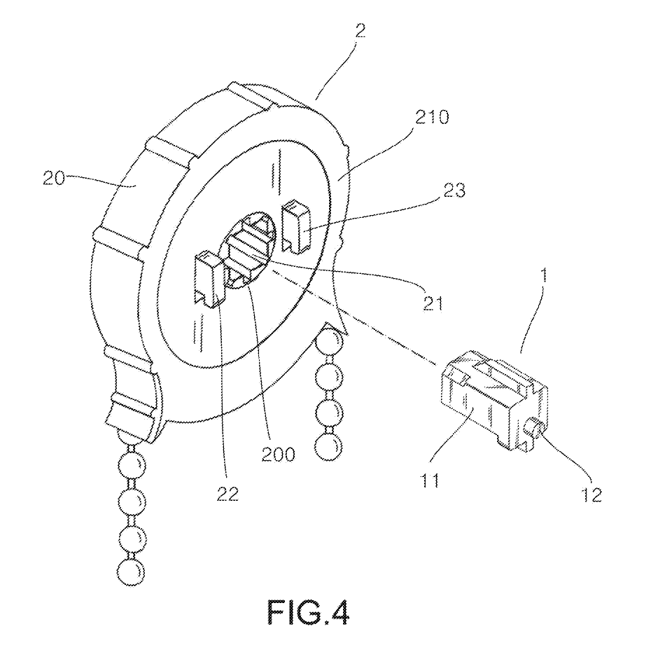

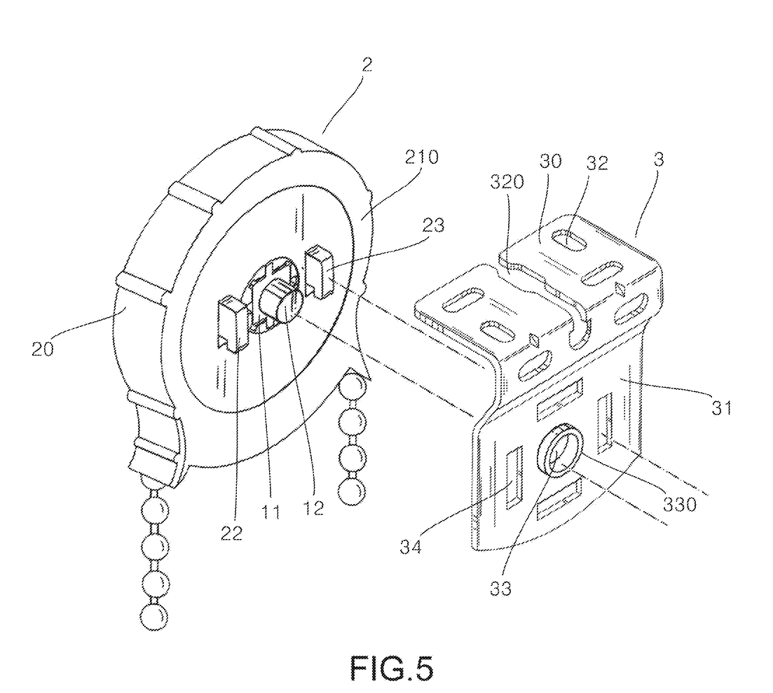

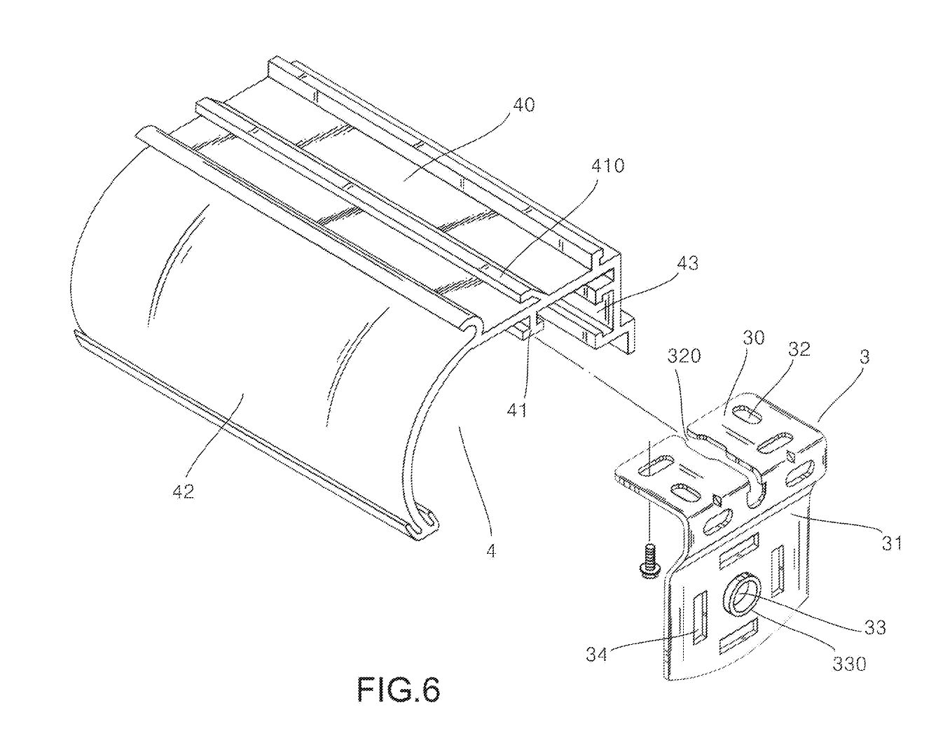

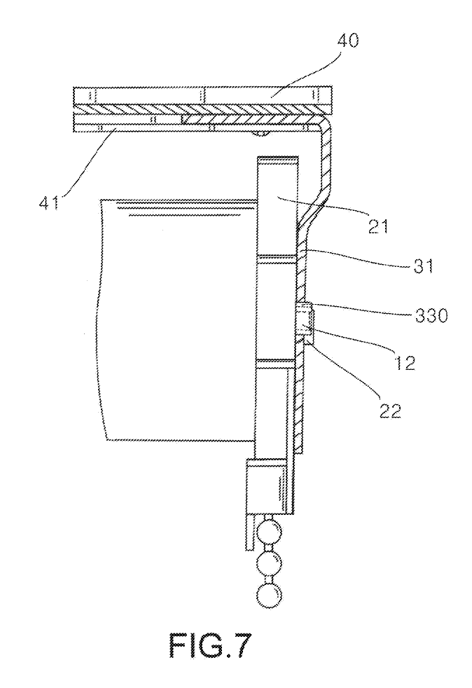

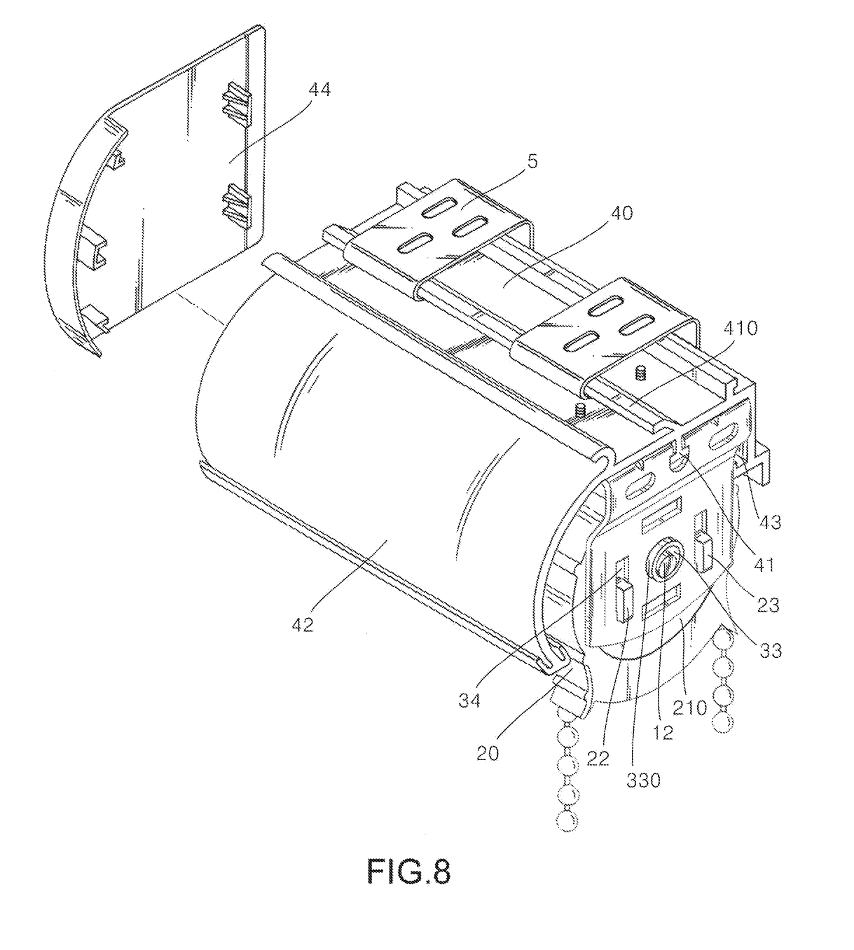

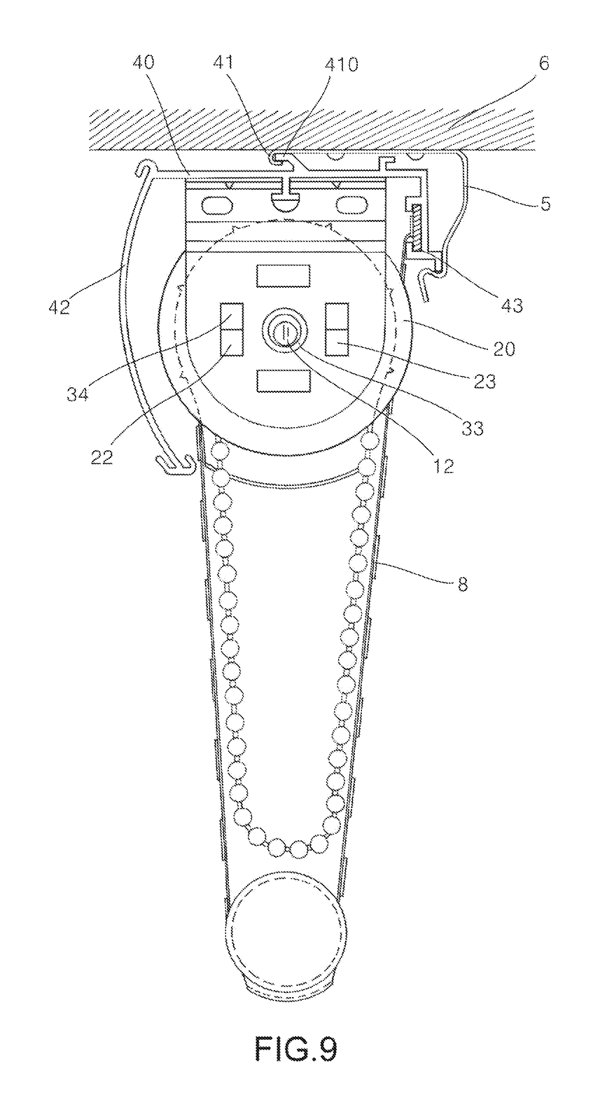

Referring to FIG. 4, when assembled, the insert body 1 is directly plugged into the central socket 200 of the control seat 20 and connected therewith. The protruding cylindrical rod section 12 is inserted into the through hole 33 of the vertical face 31 of the fixing bracket 3. Accordingly, the curtain control assembly 2 is fixedly connected onto the fixing bracket via the connection seat 21 (as shown in FIG. 5). Then the horizontal face 30 of the fixing bracket 3 is inserted into the inner face of the curtain rail 4. The reverse T-shaped structure 41 of the rail 4 passes through the split 320 of the horizontal face 30. The bottom face of the horizontal face 30 is supported on the reverse T-shaped structure 41. Accordingly, the curtain control assembly 2 is concealed in the interior space of the curtain rail 4 via the fixing bracket 3 (as shown in FIG. 7). Moreover, in order to beautify two sides of the curtain rail 4, two sides of the curtain rail 4 are closed by the cover boards 44 (as shown in FIG. 8).Finally, by means of the hanging brackets 5 fixedly hooked on the curtain rail 4, the entire curtain assembly is locked on the window wall face 6 to complete the installation (as shown in FIG. 9).

The above embodiments are only used to illustrate the present invention, not intended to limit the scope thereof. Many modifications of the above embodiments can be made without departing from the spirit of the present invention.

What is claimed is:

1. A support structure for increasing fixing force of a curtain, comprising:
an insert body including a main body with a central hollow structure and a metal pin body, which can be plugged into the hollow structure of the main body, the metal pin body having a protruding cylindrical rod section for connecting a fixing bracket and a curtain control seat;
a curtain rail including a rail main body and a reverse T-shaped structure extending from inner face of the rail main body for supporting the fixing bracket;
a curtain control seat disposed on the inner face of the rail, the curtain control seat having a central socket for the insert body to plug in, two protruding engagement bodies being disposed on two sides of the central socket, whereby the engagement bodies can be correspondingly engaged with rectangular perforations of the fixing bracket; and
a fixing bracket having a horizontal face and a vertical face, the horizontal face being formed with a split, whereby the horizontal face of the fixing bracket can be inserted into the inner face of the curtain rail with the reverse T-shaped structure of the curtain rail passing through the split, the vertical face being formed with four rectangular perforations and a central through hole.

2. The support structure for increasing fixing force of the curtain as claimed in claim 1, wherein the curtain rail further includes a receiving space for engaging the lower weight of the curtain sheet therein.

3. The support structure for increasing fixing force of the curtain as claimed in claim 1, wherein the insert body has a configuration identical to that of the central socket of the curtain control seat.

4. The support structure for increasing fixing force of the curtain as claimed in claim 1, wherein the rail further includes two hanging brackets for fixing the rail under a ceiling.

5. The support structure for increasing fixing force of the curtain as claimed in claim 1, wherein the rail further includes two cover boards for covering two sides of the rail.
